(19) United States
(12) Patent Application Publication
(10) Pub. No.: US 2019/0031857 A1
(43) Pub. Date: Jan. 31, 2019

(54) BLACK-COLORED POLYAMIDE COMPOSITION AND PRODUCTION AND USE THEREOF

(71) Applicant: BASF SE, Ludwigshafen am Rhein (DE)

(72) Inventors: Werner RAUTENBERG, Rueckersdorf (DE); Norbert MOSBACH, Maxdorf (DE); Torsten ERDMANN, Bad Blankenburg (DE)

(73) Assignee: BASF SE, Ludwigshafen am Rhein (DE)

(21) Appl. No.: 16/077,134

(22) PCT Filed: Feb. 8, 2017
(86) PCT No.: PCT/EP2017/052758

§ 371 Date: Aug. 10, 2018

(30) Foreign Application Priority Data
Feb. 22, 2016 (EP) 16156745.8

(51) Int. Cl. C08K 5/23

(52) U.S. Cl. CPC C08K 5/235

(57) ABSTRACT

The present invention relates to a polyamide composition which is dyed in black, comprising a chromium-containing azo dye in the form of a 1:2 chromium complex, to the production of such a polyamide composition and to the use thereof for the preparation of polyamide molded bodies and fibers, which are dyed in black. The invention further relates to a method for laser welding using at least one molding part on the basis of such a polyamide composition.

### BACKGROUND OF THE INVENTION

The present invention relates to a black-colored polyamide composition comprising a chromium-containing azo dye in the form of a 1:2 chromium complex, to the production of such a polyamide composition and to the use thereof for production of black-colored shaped polyamide bodies and fibers. The invention further relates to a process for laser welding using at least one molding based on such a polyamide composition.

### PRIOR ART

Polyamides are one of the polymers produced on a large scale globally and, in addition to the main fields of use in films, fibers and shaped bodies (materials), serve for a multitude of further end uses. Among the polyamides, polyamide-6 (polycaprolactam) and polyamide-6,6 (Nylon, polyhexamethyleneadipamide) are the polymers prepared in the largest volumes. Most polyamides of industrial significance are semicrystalline or amorphous thermoplastic polymers featuring a high thermal stability. The coloring and any further processing of these polyamides is effected at high temperatures of generally above 240° C. and in some cases above 300° C. This places increased demands on the colorants used, whether they are pigments or dyes, in comparison to polymers which are processed at lower temperatures, such as PVC or polyethylene.

Dyes, when used especially in semicrystalline polyamides, have a tendency to unwanted migration to the surface of the colored shaped bodies or fibers. In the case of fibers, this leads to bleeding of the dye and reduced rubfastness, and to discoloration of materials that come into contact with the fibers. Because of the property of migrating, conventional dyes are only of limited suitability for use in the polymer matrix of polyamides. By contrast, pigments can generally be used without any problem with regard to migration.

For black coloring of thermoplastics and especially polyamides, it is customary to use carbon blacks (e.g. Pigment Black 7) or only weakly migrating dyes such as Solvent Black 7 or Solvent Black 5.

WO 2015/036526 describes black thermoplastic molding compositions comprising a polymer selected from styrene copolymers, PMMA and other polyalkylmethacrylates, polycarbonates and polyestercarbonates, and a pigment black.

Carbon blacks generally exhibit good properties in the coloring of thermoplastics such as polyamides. When used in semicrystalline polymers, however, they act as nucleating agents, meaning that they lead to an increase in the number of seeds on incorporation into the molten polymer and hence affect the crystallization characteristics. The use of carbon blacks in semicrystalline polyamides leads to unwanted changes in the dimensional characteristics of the parts produced from the polyamide. This is especially problematic in the case of uses which require high dimensional stability, for example in the automotive sector in frame parts, covers, etc.

In many fields of use for black-colored polyamides, there is a need for products having high-gloss surfaces, since these are preferred, for example, by the user for esthetic reasons. The use of carbon black leads to scattering of the light hitting the colored plastic surface and hence to a loss of gloss. At the same time, the light scattering has a lightening effect, such that it is not possible to produce deep black shaped bodies with carbon black.

EP 2 716 716 A1 describes black-colored polyamide molding compositions comprising nigrosin and a nucleating agent. Nigrosin is a mixture of synthetic black colorants and is obtained by heating nitrobenzene, aniline and aniline hydrochloride in the presence of an iron or copper catalyst. They occur in various versions (water-soluble, alcohol-soluble and oil-soluble). A typical water-soluble nigrosin is Acid Black 2 (C.I. 50420), a typical alcohol-soluble nigrosin is Solvent Black 5 (C.I. 50415), and a typical oil-soluble nigrosin is Solvent Black 7 (C.I. 50415:1).

However, nigrosin is not entirely uncontroversial in terms of having a possible damaging effect on health. For example, as a result of the production, residues of aniline and nitrobenzene can remain in the product, and there is the risk of formation of unwanted breakdown products in the course of subsequent processing by means of extrusion methods, injection molding methods or spinning methods. This is not unproblematic especially in the case of use of nigrosin-colored polymers in products which come into direct contact with the skin or with food and drink, cosmetics, etc., such as fibers for clothing, food and drink packaging, etc. There is thus a need for substitute products for nigrosin for production of black-colored synthetic polyamides.

A further technical field of use for amorphous and semicrystalline thermoplastics is laser transmission welding (also referred to as laser welding for short). Laser transmission welding of plastics is based on the absorption of radiation in the molding composition. This is a joining process in which two joining partners generally made from thermoplastic polymers are joined cohesively to one another. One of these joining partners has a high transmission and the other a high absorption in the region of the laser wavelength used. The laser beam is transmitted through the joining partner having the high transmission, essentially without heating. On contact with the joining partner having the high absorption, the incident laser energy is absorbed close to the surface and converted to thermal energy, melting the polymer. Because of thermal conduction processes, the transparent component is also plasticized in the region of the joining zone. Customary laser sources used in laser transmission welding emit within a wavelength range of about 600 to 1200 nm. Examples of commonly used lasers are high-power diode lasers (HDL, A=800-1100 nm) and solid-state lasers (e.g. Nd:YAG lasers, A=1060-1090 nm). Many nonadditized polymers are substantially transparent or translucent to laser radiation, meaning that they absorb only poorly. By means of suitable colorants, but also further additives such as fillers or reinforcers, it is possible to control the absorption and hence the conversion of laser light to heat. Frequently added to the absorbent joining partner are absorbent pigments, which are usually carbon black pigments. This course of action is not possible for the laser-transparent joining partner, since carbon black-colored polymers do not have sufficient transmission for the laser light. The same applies to many organic dyes, for example nigrosin. There is thus a need for black-colored moldings which, in spite of their coloring, have sufficient transmission for the laser light, such that they can serve as the laser-transparent component in laser transmission welding. It would thus be possible to produce purely black products by laser welding.

It is an object of the present invention to provide novel black-colored polyamide compositions. At the same time, the colorant is to be advantageously suitable for bulk coloring of the polyamide, wherein the colorant is incorporated homogeneously into the polymer. The colorant is especially to feature good stability and processibility under the coloring conditions. At the same time, the aforementioned disadvantages of the colorants used to date are to be avoided.

It has been found that, surprisingly, this object is achieved when polyamide compositions are colored using the chromium complex dye designated Solvent Black 28.

### SUMMARY OF THE INVENTION

The invention firstly provides a polyamide composition comprising
a) at least one synthetic polyamide and
b) a chromium complex dye selected from the compounds of the formulae A1), A2) and A3) and mixtures of 2 or 3 of these compounds

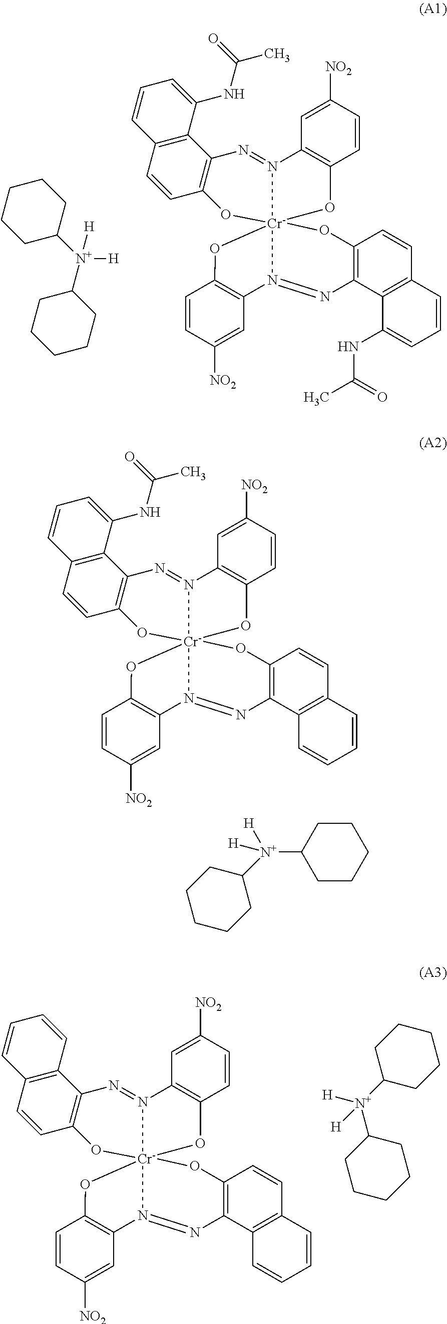

A preferred embodiment is a polyamide composition comprising
a) at least one synthetic polyamide and
b) a chromium complex dye selected from the compounds of the formulae A1), A2) and A3) and mixtures of 2 or 3 of these compounds

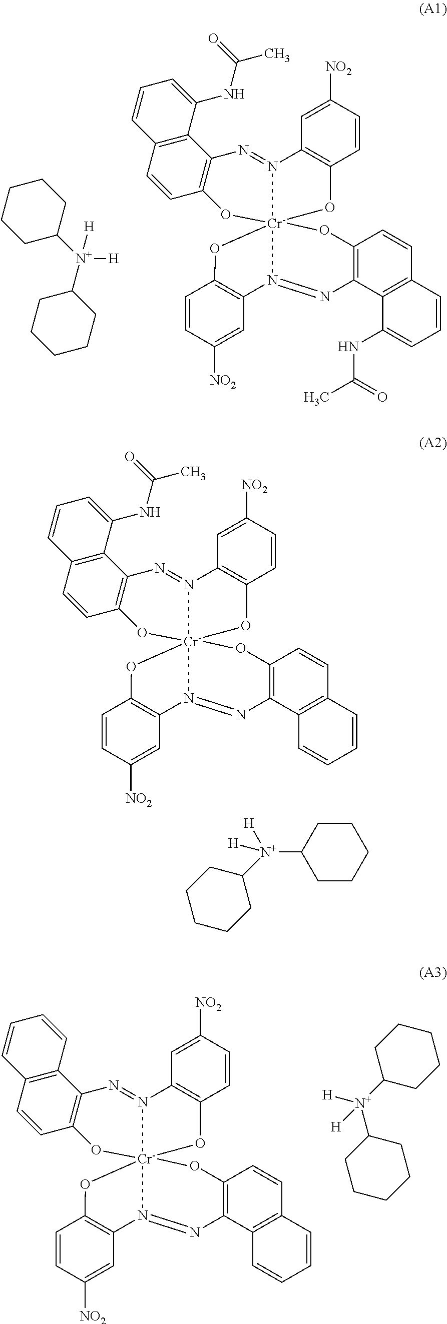

c) optionally at least one thermoplastic polymer other than component a),
d) optionally at least one colorant other than component b),
e) optionally at least one filler and reinforcer,
f) optionally at least one additive other than components a) to e).

The invention further provides for the use of a chromium complex dye selected from the compounds of the formulae A1), A2) and A3) and mixtures of 2 or 3 of these compounds for production of black-colored synthetic polyamides.

The invention further provides for the use of a polyamide composition as defined above and hereinafter for production of black-colored shaped polyamide bodies having high thermal stability.

The invention further provides a shaped body produced from a polyamide molding composition of the invention, as defined above and hereinafter.

The invention further provides polyamide fibers produced from a polyamide molding composition of the invention, as defined above and hereinafter.

The invention further provides a process for producing a polyamide composition as defined above and hereinafter, in which at least one synthetic polyamide a), at least one chromium complex dye b) and optionally further additives are mixed with one another while heating to a temperature in the range from 160 to 340° C.

The invention further provides for the use of a polyamide composition as defined above and hereinafter for production of moldings for laser transmission welding. The polyamide composition of the invention is especially suitable for production of laser-transparent moldings.

### PREFERRED EMBODIMENTS OF THE INVENTION

The invention encompasses the following preferred embodiments:

1. A polyamide composition comprising
a) at least one synthetic polyamide and
b) a chromium complex dye selected from the compounds of the formulae A1), A2) and A3) and mixtures of 2 or 3 of these compounds

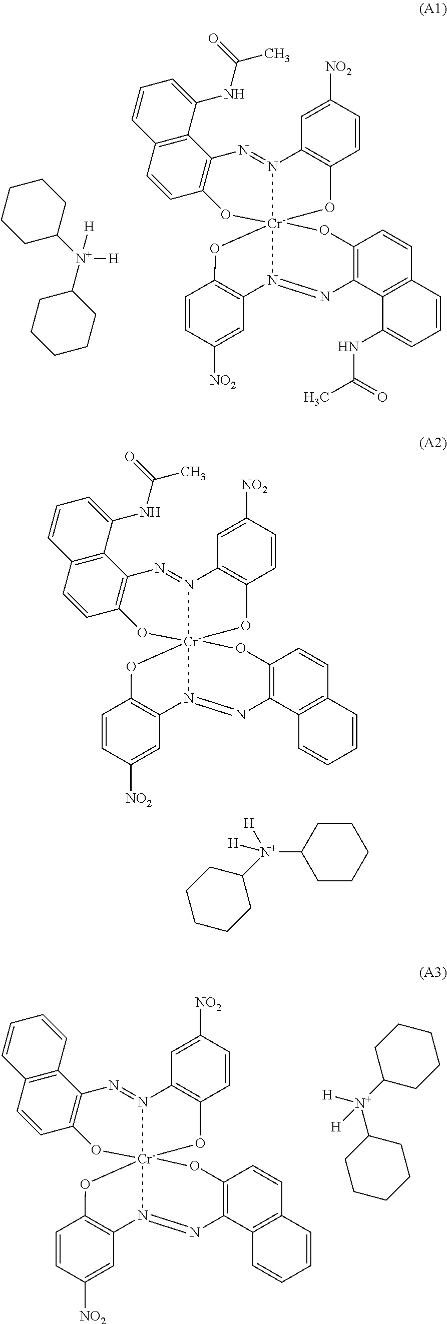

2. The polyamide composition according to embodiment 1, wherein the polyamide is selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, PA 6.T, PA 9.T, PA8.T, PA 10.T, PA 12.T, PA 6.I, PA 8.I, PA 9.I, PA 10.I, PA 12.I, PA 6.T/6, PA 6.T/10, PA 6.T/12, PA 6.T/6.I, PA6.T/8.T, PA 6.T/9.T, PA 6.T/10T, PA 6.T/12.T, PA 12.T/6.T, PA 6.T/6.I/6, PA 6.T/6.I/12, PA 6.I/6.I/6.10, PA 6.T/6.I/6.12, PA 6.T/6.6, PA 6.T/6.10, PA 6.T/6.12, PA 10.T/6, PA 10.T/11, PA 10.I/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10T/10.I/6.T, PA 10.T/6.I, PA 4.T/4.I/46, PA 4.T/4.I/6.6, PA 5.T/5.I, PA 5.T/5.I/5.6, PA 5.T/5.I/6.6, PA 6.T/6.I/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.I/8.T/8.I, PA 6.T/6.I/10.T/10.I, PA 6.T/6.I/IPDA.T/IPDA.I, PA 6.T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T and copolymers and mixtures thereof.
3. The polyamide composition according to embodiment 1, wherein the polyamide is selected from PA 6, PA 66, PA 666 and PA 12.
4. The polyamide composition according to any of the preceding embodiments, comprising the chromium complex dye b) in an amount of 0.0001% by weight to 5% by weight, preferably of 0.001% by weight to 2% by weight, especially of 0.01% by weight to 1% by weight, based on the total weight of the polyamide composition.
5. A polyamide composition comprising
   a) at least one synthetic polyamide,
   b) a chromium complex dye selected from the compounds of the formulae A1), A2) and A3) and mixtures of 2 or 3 of these compounds

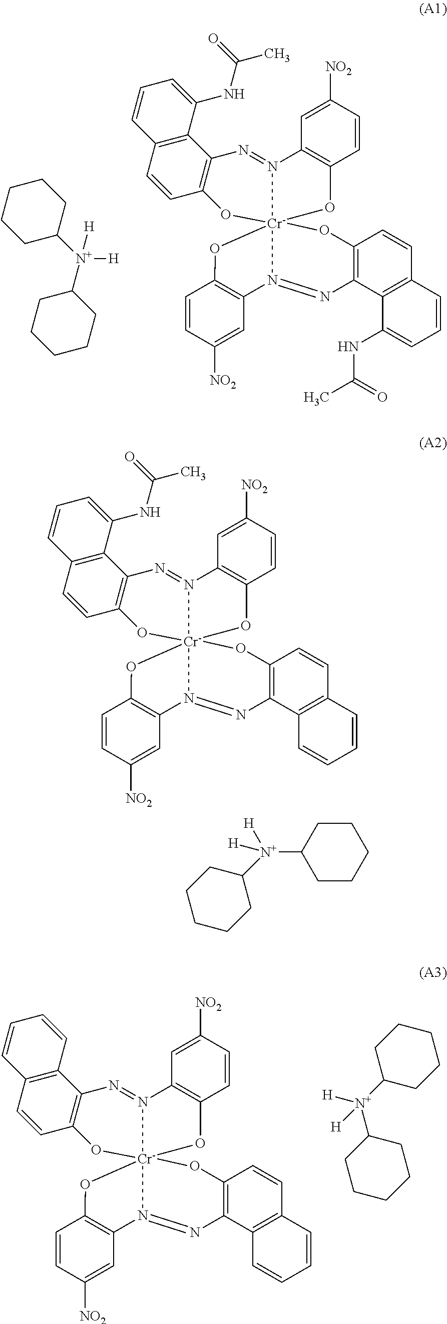

c) optionally at least one thermoplastic polymer other than component a),
d) optionally at least one colorant other than component b),
e) optionally at least one filler and reinforcer,
f) optionally at least one additive other than components a) to e).
6. The polyamide composition according to embodiment 5, comprising
   a) 5% by weight to 99.9999% by weight of at least one synthetic polyamide and
   b) 0.0001% by weight to 5% by weight of a chromium complex dye selected from the compounds of the formulae A1), A2) and A3) and mixtures of 2 or 3 of these compounds,
   c) 0% by weight to 94.9999% by weight of at least one thermoplastic polymer other than component a),
   d) 0% by weight to 10% by weight of at least one colorant other than component b),
   f) 0% by weight to 50% by weight of at least one additive other than components a) to f), with the proviso that components a), b), c), d) and f) add up to 100% by weight.
7. The polyamide composition according to embodiment 5 or 6, wherein the weight ratio of the total weight of components a), b), c), d) and f) to component e) is 25:75 to 100:0.
8. The polyamide composition according to any of embodiments 5 to 7, wherein component c) is selected from
   homo- or copolymers which comprise, in polymerized form, at least one monomer selected from C₂-C₁₀ monoolefins, for example ethylene or propylene, 1,3-butadiene, 2-chloro-1,3-butadiene, vinyl alcohol and the C₂-C₁₀-alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C₁₀-alcohols, vinylaromatics, for example styrene, acrylonitrile, methacrylonitrile, α,β-ethylenically unsaturated mono- and dicarboxylic acids, and maleic anhydride;
   homo- and copolymers of vinyl acetals;
   polyvinyl esters;
   polycarbonates (PC);
   polyesters such as polyalkylene terephthalates, polyhydroxyalkanoates (PHA), polybutylene succinates (PBS), polybutylene succinate adipates (PBSA);
   polyethers;
   polyether ketones;
   thermoplastic polyurethanes (TPU);
   polysulfides;
   polysulfones;
   polyether sulfones;
   cellulose alkyl esters;
   and mixtures thereof.
9. The polyamide composition according to any of embodiments 5 to 8, wherein component c) is selected from styrene copolymers, polyalkyl(meth)acrylates, polycarbonates and mixtures thereof.
10. The polyamide composition according to any of embodiments 5 to 9, wherein component d) comprises at least one non-nucleating colorant other than b).
11. The polyamide composition according to any of embodiments 5 to 10, wherein component d) comprises at least one white pigment.
12. The polyamide composition according to any of embodiments 5 to 11, having, in the CIELAB color space according to DIN 6174 with the specular component included, an L* value of not more than 30.
13. The polyamide composition according to any of embodiments 5 to 12, having, in the CIELAB color space according to DIN 6174 with the specular component excluded, an L* value of not more than 20.
14. The use of a chromium complex dye selected from the compounds of the formulae A1), A2) and A3) and mixtures of 2 or 3 of these compounds

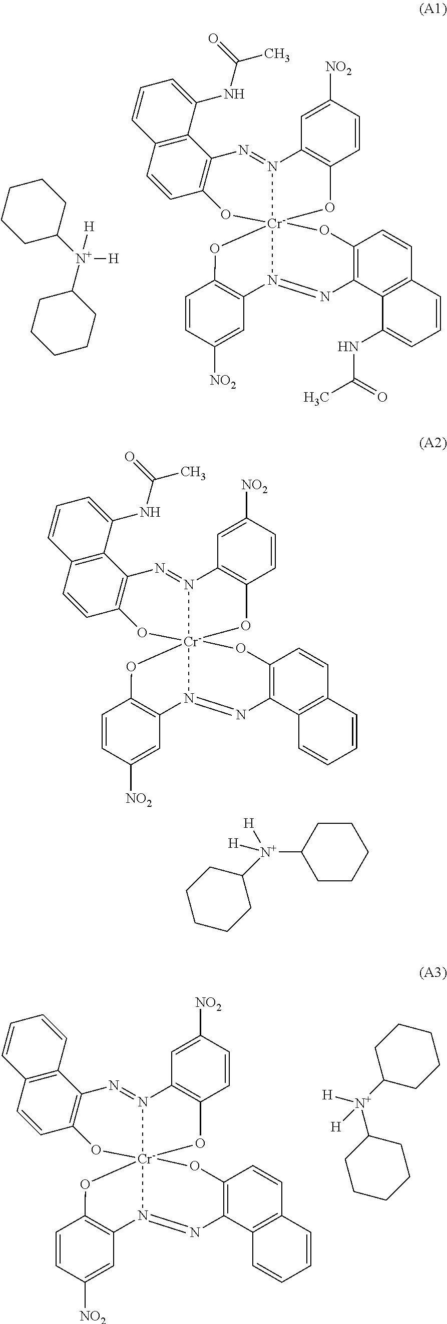

for production of black-colored synthetic polyamides.
15. The use of a polyamide composition as defined in any of embodiments 1 to 13 for production of black-colored shaped polyamide bodies having high thermal stability.
16. The use of a polyamide composition as defined in any of embodiments 1 to 13 for production of moldings for use in motor vehicles, domestic appliances, electrical appliances, decorative strips and exterior paneling.
17. A shaped body produced from a polyamide molding composition according to any of embodiments 1 to 13.
18. Polyamide fibers produced from a polyamide molding composition according to any of embodiments 1 to 13.
19. A process for producing a polyamide composition as defined in any of embodiments 1 to 13, in which at least one synthetic polyamide a), at least one chromium complex dye b) and optionally further additives are mixed with one another while heating to a temperature in the range from 160 to 340° C.
20. The process according to embodiment 19, wherein the polyamide used has a water content of not more than 2% by weight, preferably of not more than 1% by weight, especially of not more than 0.5% by weight.
21. The use of a polyamide composition as defined in any of embodiments 1 to 13 for production of moldings for laser transmission welding.
22. The use according to embodiment 21 for production of laser-transparent moldings.

### DESCRIPTION OF THE INVENTION

The invention has the following advantages:
The chromium complex dye used in accordance with the invention essentially does not act as a nucleating agent and hence does not lead to any relevant change in the crystallization characteristics of the polyamide colored therewith. It is thus possible to avoid unwanted changes in the dimensional characteristics of the shaped bodies produced from the colored polyamides.
The chromium complex dye used in accordance with the invention additionally does not exhibit any unwanted migration in semicrystalline polyamides. Fibers based on the polyamide composition of the invention feature low bleeding and high rubfastness.
The chromium complex dye used in accordance with the invention is of much lower toxicological concern than nigrosin, for example.
The polyamides colored in accordance with the invention and shaped bodies and fibres produced therefrom feature very good colorfastness, very good thermal stability and/or very good processibility. What is particularly surprising in this context is the high thermal stability of the polyamides colored with Solvent Black 28. For instance, Solvent Black 28 in the attempted bulk coloring of polyethylene showed an entirely inadequate thermal stability which made processing at temperatures even over and above 160° C. impossible.
With the chromium complex dye used in accordance with the invention, it is possible to produce products with high-gloss surfaces. In addition, the production of deep black polyamide products is also possible.
The chromium complex dye used in accordance with the invention has a much higher transmission in the wavelength range from about 600 to 1200 nm used in laser transmission welding than dyes known from the prior art for polyamide and especially nigrosin. The polyamide compositions produced therefrom are thus suitable for production of laser-transparent moldings for laser transmission welding.

Synthetic Polyamide a)

The polyamide composition of the invention comprises, as component a), at least one synthetic polyamide. The term “synthetic polyamide” is understood in a broad manner in the context of the invention. It quite generally covers polymers incorporating at least one component which is suitable for polyamide formation and is selected from dicarboxylic acids, diamines, salts of at least one dicarboxylic acid and at least one diamine, lactams, ω-amino acids, aminocarbonitriles and mixtures thereof. As well as the components suitable for polyamide formation, the synthetic polyamides of the invention may also comprise monomers copolymerizable therewith in copolymerized form. The term “synthetic polyamide” does not include natural polyamides, such as peptides and proteins, for example hair, wool, silk and albumen.

The polyamides are designated in the context of the invention using abbreviations, some of which are customary in the art, which consist of the letters PA followed by numbers and letters. Some of these abbreviations are standardized in DIN EN ISO 1043-1. Polyamides which can be derived from aminocarboxylic acids of the H₂N—(CH₂)ₓ—COOH type or the corresponding lactams are identified as PA Z where Z denotes the number of carbon atoms in the monomer. For example, PA 6 represents the polymer of ϵ-caprolactam or of ω-aminocaproic acid. Polyamides derivable from diamines and dicarboxylic acids of the H₂N—(CH₂)ₓ—NH₂ and HOOC—(CH₂)_{y}—COOH types are identified as PA Z1Z2 where Z1 denotes the number of carbon atoms in the diamine and Z2 the number of carbon atoms in the dicarboxylic acid. Copolyamides are designated by listing the components in the sequence of their proportions, separated by slashes. For example, PA 66/610 is the copolyamide of hexamethylenediamine, adipic acid and sebacic acid. For the monomers having an aromatic or cycloaliphatic group which are used in accordance with the invention, the following letter abbreviations are used:

T=terephthalic acid,

I=isophthalic acid,

MXDA=m-xylylenediamine,

IPDA=isophoronediamine,

PACM=4,4′-methylenebis(cyclohexylamine),

MACM=2,2′-dimethyl-4,4′-methylenebis(cyclohexylamine).

Hereinafter, the expression “C₁-C₄-alkyl” encompasses unsubstituted straight-chain and branched C₁-C₄-alkyl groups. Examples of C₁-C₄-alkyl groups are especially methyl, ethyl, propyl, isopropyl, n-butyl, isobutyl, sec-butyl, tert-butyl (1,1-dimethyl-ethyl).

In the aliphatic dicarboxylic acids, cycloaliphatic dicarboxylic acids, aromatic dicarboxylic acids and monocarboxylic acids mentioned hereinafter, the carboxyl groups may each be present in underivatized form or in the form of derivatives. In the case of dicarboxylic acids, neither carboxyl group, one carboxyl group or both carboxyl groups may be in the form of a derivative. Suitable derivatives are anhydrides, esters, acid chlorides, nitriles and isocyanates. Preferred derivatives are anhydrides or esters. Anhydrides of dicarboxylic acids may be in monomeric or in polymeric form. Preferred esters are alkyl esters and vinyl esters, more preferably C₁-C₄-alkyl esters, particularly methyl esters or ethyl esters. Dicarboxylic acids are preferably in the form of mono- or dialkyl esters, more preferably mono- or di-C₁-C₄-alkyl esters, more preferably monomethyl esters, dimethyl esters, monoethyl esters or diethyl esters. Dicarboxylic acids are moreover preferably in the form of mono- or divinyl esters. Dicarboxylic acids are moreover preferably in the form of mixed esters, more preferably mixed esters comprising different C₁-C₄-alkyl components, especially methyl ethyl esters.

The components suitable for polyamide formation are preferably selected from
A) unsubstituted or substituted aromatic dicarboxylic acids and derivatives of unsubstituted or substituted aromatic dicarboxylic acids,
B) unsubstituted or substituted aromatic diamines,
C) aliphatic or cycloaliphatic dicarboxylic acids,
D) aliphatic or cycloaliphatic diamines,
E) monocarboxylic acids,
F) monoamines,
G) at least trifunctional amines,
H) lactams,
I) ω-amino acids,
K) compounds which are different than A) to I) and are cocondensable therewith.

A suitable embodiment is aliphatic polyamides. For aliphatic polyamides of the PA Z1 Z2 type (such as PA 66), the proviso applies that at least one of components C) and D) must be present and neither of components A) and B) may be present. For aliphatic polyamides of the PAZ type (such as PA 6 or PA 12), the proviso applies that at least component H) must be present.

A further suitable embodiment is semiaromatic polyamides. For semiaromatic polyamides, the proviso applies that at least one of components A) and B) and at least one of components C) and D) must be present.

The aromatic dicarboxylic acids A) are preferably selected from in each case unsubstituted or substituted phthalic acid, terephthalic acid, isophthalic acid, naphthalenedicarboxylic acids or diphenyldicarboxylic acids, and the derivatives and mixtures of the aforementioned aromatic dicarboxylic acids.

Substituted aromatic dicarboxylic acids A) preferably have at least one (e.g. 1, 2, 3 or 4) C₁-C₄-alkyl radical. More particularly, substituted aromatic dicarboxylic acids A) have 1 or 2 C₁-C₄-alkyl radicals. These are preferably selected from methyl, ethyl, n-propyl, isopropyl, n-butyl, isobutyl, sec-butyl and tert-butyl, more preferably methyl, ethyl and n-butyl, particularly methyl and ethyl and especially methyl. Substituted aromatic dicarboxylic acids A) may also bear further functional groups which do not disrupt the amidation, for example 5-sulfoisophthalic acid, and salts and derivatives thereof. A preferred example thereof is the sodium salt of dimethyl 5-sulfoisophthalate.

Preferably, the aromatic dicarboxylic acid A) is selected from unsubstituted terephthalic acid, unsubstituted isophthalic acid, unsubstituted naphthalenedicarboxylic acids, 2-chloroterephthalic acid, 2-methylterephthalic acid, 5-methylisophthalic acid and 5-sulfoisophthalic acid.

More preferably, the aromatic dicarboxylic acid A) used is terephthalic acid, isophthalic acid or a mixture of terephthalic acid and isophthalic acid.

Preferably, the semiaromatic polyamides prepared by the process of the invention (and the prepolymers provided in step a)) have a proportion of aromatic dicarboxylic acids among all the dicarboxylic acids of at least 50 mol %, more preferably of 70 mol % to 100 mol %. In a specific embodiment, the semiaromatic polyamides prepared by the process of the invention (and the prepolymers provided in step a)) have a proportion of terephthalic acid or isophthalic acid or a mixture of terephthalic acid and isophthalic acid, based on all the dicarboxylic acids, of at least 50 mol %, preferably of 70 mol % to 100 mol %.

The aromatic diamines B) are preferably selected from bis(4-aminophenyl)methane, 3-methylbenzidine, 2,2-bis(4-aminophenyl)propane, 1,1-bis(4-aminophenyl)cyclohexane, 1,2-diaminobenzene, 1,4-diaminobenzene, 1,4-diaminonaphthalene, 1,5-diaminonaphthalene, 1,3-diaminotoluene(s), m-xylylenediamine, N,N′-dimethyl-4,4′-biphenyldiamine, bis(4-methylaminophenyl)methane, 2,2-bis(4-methylaminophenyl) propane or mixtures thereof.

The aliphatic or cycloaliphatic dicarboxylic acids C) are preferably selected from oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, maleic acid, fumaric acid or itaconic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and mixtures thereof.

The aliphatic or cycloaliphatic diamines D) are preferably selected from ethylene diamine, propylenediamine, tetramethylenediamine, heptamethylenediamine, hexamethylenediamine, pentamethylenediamine, octamethylenediamine, nonamethylene diamine, decamethylenediamine, undecamethylenediamine, dodecamethylenediamine, 2-methylpentamethylenediamine, 2,2,4-trimethylhexamethylenediamine, 2,4,4-trimethylhexamethylenediamine, 5-methylnonamethylene diamine, 2,4-dimethylocta-methylenediamine, 5-methylnonanediamine, bis(4-aminocyclohexyl)methane, 3,3′-dimethyl-4,4′-diaminodicyclohexylmethane and mixtures thereof.

More preferably, the diamine D) is selected from hexamethylenediamine, 2-methylpentamethylenediamine, octamethylenediamine, nonamethylenediamine, 2-methyl-1,8-octamethylenediamine, decamethylenediamine, undecamethylenediamine, dodecamethylenediamine, bis(4-aminocyclohexyl)methane, 3,3′-dimethyl-4,4′-diaminodicyclohexylmethane and mixtures thereof.

In a specific embodiment, the semiaromatic polyamides comprise at least one copolymerized diamine D) selected from hexamethylenediamine, bis(4-aminocyclohexyl)methane (PACM), 3,3′-dimethyl-4,4′-diaminodicyclohexylmethane (MACM), isophoronediamine (IPDA) and mixtures thereof.

In a specific embodiment, the semiaromatic polyamides comprise exclusively hexamethylenediamine as the copolymerized diamine D).

In a further specific embodiment, the semiaromatic polyamides comprise exclusively bis(4-aminocyclohexyl)methane as the copolymerized diamine D).

In a further specific embodiment, the semiaromatic polyamides comprise exclusively 3,3′-dimethyl-4,4′-diaminodicyclohexylmethane (MACM) as the copolymerized diamine D).

In a further specific embodiment, the semiaromatic polyamides comprise exclusively isophoronediamine (IPDA) as the copolymerized diamine D).

The aliphatic and the semiaromatic polyamides may comprise at least one copolymerized monocarboxylic acid E). The monocarboxylic acids E) serve to end-cap the polyamides prepared in accordance with the invention. Suitable monocarboxylic acids are in principle all of those capable of reacting with at least some of the amino groups available under the reaction conditions of the polyamide condensation. Suitable monocarboxylic acids E) are aliphatic monocarboxylic acids, alicyclic monocarboxylic acids and aromatic monocarboxylic acids. These include acetic acid, propionic acid, n-, iso- or tert-butyric acid, valeric acid, trimethylacetic acid, caproic acid, enanthic acid, caprylic acid, pelargonic acid, capric acid, undecanoic acid, lauric acid, tridecanoic acid, myristic acid, palmitic acid, stearic acid, pivalic acid, cyclohexanecarboxylic acid, benzoic acid, methylbenzoic acids, α-naphthalenecarboxylic acid, β-naphthalenecarboxylic acid, phenylacetic acid, oleic acid, ricinoleic acid, linoleic acid, linolenic acid, erucic acid, fatty acids from soya, linseeds, castor oil plants and sunflowers, acrylic acid, methacrylic acid, Versatic® acids, Koch® acids and mixtures thereof.

If the monocarboxylic acids E) used are unsaturated carboxylic acids or derivatives thereof, it may be advisable to work in the presence of commercial polymerization inhibitors.

More preferably, the monocarboxylic acid E) is selected from acetic acid, propionic acid, benzoic acid and mixtures thereof.

In a specific embodiment, the aliphatic and the semiaromatic polyamides comprise exclusively propionic acid as the copolymerized monocarboxylic acid E).

In a further specific embodiment, the aliphatic and the semiaromatic polyamides comprise exclusively benzoic acid as the copolymerized monocarboxylic acid E).

In a further specific embodiment, the aliphatic and the semiaromatic polyamides comprise exclusively acetic acid as the copolymerized monocarboxylic acid E).

The aliphatic and the semiaromatic polyamides may comprise at least one copolymerized monoamine F). In this case, the aliphatic polyamides comprise only copolymerized aliphatic monoamines or alicyclic monoamines. The monoamines F) serve to end-cap the polyamides prepared in accordance with the invention. Suitable monoamines are in principle all of those capable of reacting with at least some of the carboxylic acid groups available under the reaction conditions of the polyamide condensation. Suitable monoamines F) are aliphatic monoamines, alicyclic monoamines and aromatic monoamines. These include methylamine, ethylamine, propylamine, butylamine, hexylamine, heptylamine, octylamine, decylamine, stearyl amine, dimethylamine, diethylamine, dipropylamine, dibutylamine, cyclohexylamine, dicyclohexylamine, aniline, toluidine, diphenylamine, naphthylamine and mixtures thereof.

For preparation of the aliphatic and the semiaromatic polyamides, it is additionally possible to use at least one at least trifunctional amine G). These include N′-(6-amino-hexyl)hexane-1,6-diamine, N′-(12-aminododecyl)dodecane-1,12-diamine, N′-(6-amino-hexyl)dodecane-1,12-diamine, N′-[3-(aminomethyl)-3,5,5-trimethylcyclohexyl]hexane-1,6-diamine, N′-[3-(aminomethyl)-3,5,5-trimethylcyclohexyl]dodecane-1,12-diamine, N′-[(5-amino-1,3,3-trimethylcyclohexyl)methyl]hexane-1,6-diamine, N′-[(5-amino-1,3,3-trimethylcyclohexyl)methyl]dodecane-1,12-diamine, 3-[[[3-(aminomethyl)-3,5,5-trimethylcyclohexyl]amino]methyl]-3,5,5-trimethylcyclohexanamine, 3-[[(5-amino-1,3,3-trimethylcyclohexyl)methylamino]methyl]-3,5,5-trimethylcyclohexanamine, 3-(amino-methyl)-N-[3-(aminomethyl)-3,5,5-trimethylcyclohexyl]-3,5,5-trimethylcyclohexanamine. Preferably, no at least trifunctional amines G) are used.

Suitable lactams H) are ε-caprolactam, 2-piperidone (δ-valerolactam), 2-pyrrolidone (γ-butyrolactam), capryllactam, enantholactam, lauryllactam and mixtures thereof.

Suitable ω-amino acids I) are 6-aminocaproic acid, 7-aminoheptanoic acid, 11-amino-undecanoic acid, 12-aminododecanoic acid and mixtures thereof.

Suitable compounds K) which are different than A) to I) and are cocondensable therewith are at least tribasic carboxylic acids, diaminocarboxylic acids, etc.

Suitable compounds K) are additionally 4-[(Z)—N-(6-aminohexyl)-C-hydroxycarbonimidoyl]benzoic acid, 3-[(Z)—N-(6-aminohexyl)-C-hydroxycarbonimidoyl]benzoic acid, (6Z)-6-(6-aminohexylimino)-6-hydroxyhexanecarboxylic acid, 4-[(Z)—N-[(5-amino-1,3,3-trimethylcyclohexyl)methyl]-C-hydroxycarbonimidoyl]benzoic acid, 3-[(Z)—N-[(5-amino-1,3,3-trimethylcyclohexyl)methyl]-C-hydroxycarbonimidoyl]benzoic acid, 4-[(Z)—N-[3-(aminomethyl)-3,5,5-trimethylcyclohexyl]-C-hydroxycarbonimidoyl]benzoic acid, 3-[(Z)—N-[3-(aminomethyl)-3,5,5-trimethylcyclohexyl]-C-hydroxycarbonimidoyl]benzoic acid and mixtures thereof.

Preferably, the polyamide a) is selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, PA 6.T, PA 9.T, PA8.T, PA 10.T, PA 12.T, PA 6.I, PA 8.I, PA 9.I, PA 10.I, PA 12.I, PA 6.T/6, PA 6.T/10, PA 6.T/12, PA 6.T/6.I, PA6.T/8.T, PA 6.T/9.T, PA 6.T/10T, PA 6.T/12.T, PA 12.T/6.T, PA 6.T/6.I/6, PA 6.T/6.I/12, PA 6.T/6.I/6.10, PA 6.T/6.I/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10T/10.I/6.T, PA 10.T/6.I, PA 4.T/4.I/46, PA 4.T/4.I/6.6, PA 5.T/5.I, PA 5.T/5.I/5.6, PA 5.T/5.I/6.6, PA 6.T/6.I/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.I/8.T/8.I, PA 6.T/6.I/10.T/10.I, PA 6.I/6.I/IPDA.T/IPDA.I, PA 6.T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T and copolymers and mixtures thereof.

In a preferred embodiment, the polyamide composition of the invention comprises at least one aliphatic polyamide as component a).

In that case, the polyamide is preferably selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, and copolymers and mixtures thereof.

The aliphatic polyamide a) is especially selected from PA 6, PA 66, PA 666 and PA 12. A specific embodiment is polyamide compositions in which component a) comprises PA 6 or consists of PA 6.

In a further preferred embodiment, the process according to the invention serves for preparation of a semiaromatic polyamide.

In that case, the polyamide a) is preferably selected from PA 6.T, PA 9.T, PA 10.T, PA 12.T, PA 6.I, PA 9.I, PA 10.I, PA 12.I, PA 6.T/6.I, PA 6.T/6, PA6.T/8.T, PA 6.T/10T, PA 10.T/6.T, PA 6.T/12.T, PA12.T/6.T, PA IPDA.I, PA IPDA.T, PA 6.T/IPDA.T, PA 6.T/6.I/IPDA.T/IPDA.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T, and copolymers and mixtures thereof.

The figures which follow for the number-average molecular weight Mₙ and for the weight-average molecular weight M_{w} in the context of this invention are each based on a determination by means of gel permeation chromatography (GPC). For calibration, PMMA, for example, was used as a polymer standard with a low polydispersity.

The synthetic polyamide a) preferably has a number-average molecular weight Mₙ within a range from 8000 to 50 000 g/mol, more preferably from 10 000 to 35 000 g/mol.

The synthetic polyamide a) preferably has a weight-average molecular weight M_{w} within a range from 15 000 to 200 000 g/mol, more preferably from 20 000 to 125 000 g/mol.

The polyamides a) preferably have a polydispersity PD (=M_{w}/Mₙ) of not more than 6, more preferably of not more than 5, especially of not more than 3.5.

The chromium complex dye b) used in accordance with the invention is available under the name Solvent Black 28 (CAS no.: 12237-23-9, C.I. Solvent Black 28). A commercially available product is Orasol Black 045 from BASF SE. Solvent Black 28 is almost water-insoluble, but has good solubility in alcoholic or ketone group-containing organic solvents. Solubility at 20° C. in ethanol is about 10 g/L and in methyl ethyl ketone about 400 g/L.

Preferably, the polyamide composition of the invention comprises the chromium complex dye b) in an amount of 0.0001% by weight to 5% by weight, more preferably of 0.001% by weight to 2% by weight, especially of 0.01% by weight to 1% by weight, based on the total weight of the polyamide composition.

Polyamide Molding Composition

The invention further provides a polyamide molding composition comprising components a) and b).

Preference is given to a polyamide molding composition comprising:
a) at least one synthetic polyamide,
b) a chromium complex dye selected from the compounds of the formulae A1), A2) and A3) and mixtures of 2 or 3 of these compounds

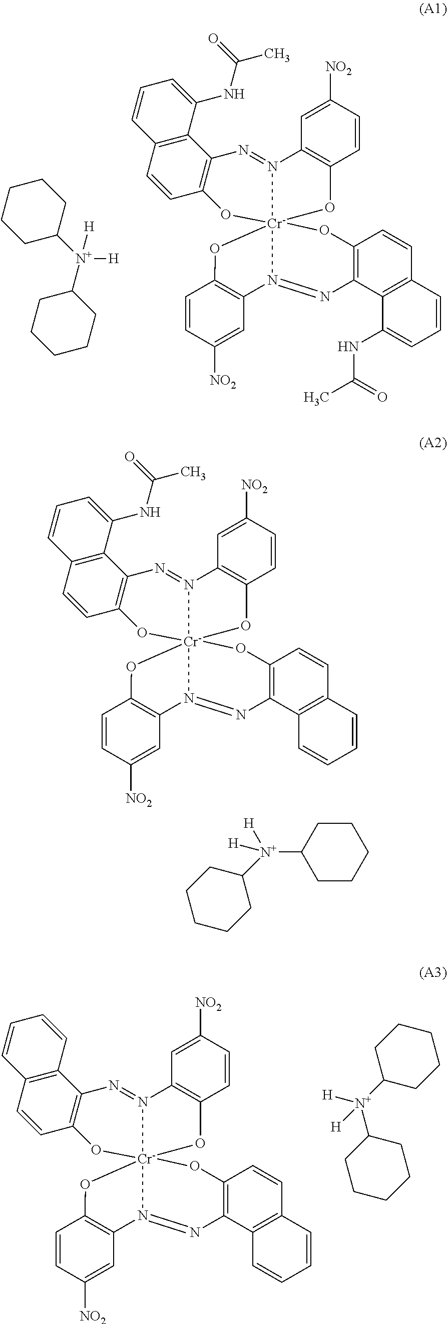

c) optionally at least one thermoplastic polymer other than component a),
d) optionally at least one colorant other than component b),
e) optionally at least one filler and reinforcer,
f) optionally at least one additive other than components a) to e).

A preferred polyamide composition comprises
a) 5% by weight to 99.9999% by weight of at least one synthetic polyamide and
b) 0.0001% by weight to 5% by weight of a chromium complex dye selected from the compounds of the formulae A1), A2) and A3) and mixtures of 2 or 3 of these compounds,
c) 0% by weight to 94.9999% by weight of at least one thermoplastic polymer other than component a),
d) 0% by weight to 10% by weight of at least one colorant other than component b),
f) 0% by weight to 50% by weight of at least one additive other than components a) to f),
   with the proviso that components a), b), c), d) and f) add up to 100% by weight.

Preferably, the polyamide composition of the invention comprises, to 100 parts by weight of the total weight of components a), b), c), d) and f), 0 to 75 parts by weight of at least one filler and reinforcer e). More preferably, the polyamide composition of the invention comprises, to 100 parts by weight of the total weight of components a), b), c), d) and f), 25 to 75 parts by weight, especially 33 to 60 parts by weight, of at least one filler and reinforcer e).

Preferably, the weight ratio of the total weight of components a), b), c), d) and f) to component e) is 25:75 to 100:0.

Preferably, the polyamide composition of the invention comprises 10% by weight to 99.999% by weight, more preferably 25% by weight to 99.99% by weight, particularly 50% by weight to 99.9% by weight, especially 75% by weight to 98% by weight, of at least one synthetic polyamide a), based on the total weight of components a), b), c), d) and f).

Preferably, the polyamide composition of the invention comprises 0.001% by weight to 2% by weight, more preferably 0.01% by weight to 1% by weight, of at least one chromium complex dye b), based on the total weight of components a), b), c), d) and f).

When the polyamide composition of the invention comprises at least one thermoplastic polymer c) other than component a), it preferably comprises 0.5% to 75% by weight, more preferably 1% to 50% by weight, based on the total weight of components a), b), c), d) and f).

When the polyamide composition of the invention comprises at least one colorant d) other than component b), it preferably comprises 0.0001% by weight to 5% by weight, more preferably 0.001% by weight to 2% by weight, especially 0.01% by weight to 1% by weight, based on the total weight of components a), b), c), d) and f).

Component c) is preferably selected from
homo- or copolymers which comprise, in polymerized form, at least one monomer selected from C₂-C₁₀ monoolefins, for example ethylene or propylene, 1,3-butadiene, 2-chloro-1,3-butadiene, vinyl alcohol and the C₂-C₁₀-alkyl esters thereof, vinyl chloride, vinylidene chloride, vinylidene fluoride, tetrafluoroethylene, glycidyl acrylate, glycidyl methacrylate, acrylates and methacrylates with alcohol components of branched and unbranched C₁-C₁₀-alcohols, vinylaromatics, for example styrene, acrylonitrile, methacrylonitrile, α,β-ethylenically unsaturated mono- and dicarboxylic acids, and maleic anhydride;
homo- and copolymers of vinyl acetals;
polyvinyl esters;
polycarbonates (PC);
polyesters such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
polyether sulfones;
cellulose alkyl esters;
   and mixtures thereof.

Mention should be made, for example, of polyacrylates having identical or different alcohol residues from the group of the C₄-C₈ alcohols, particularly of butanol, hexanol, octanol and 2-ethylhexanol, polymethylmethacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethyl cellulose (EC), cellulose acetate (CA), cellulose propionate (CP) or cellulose acetate/butyrate (CAB).

The at least one thermoplastic polymer present in the molding composition of the invention is preferably polyvinyl chloride (PVC), polyvinyl butyral (PVB), homo- and copolymers of vinyl acetate, homo- and copolymers of styrene, polyacrylates, thermoplastic polyurethanes (TPUs) or polysulfides.

It may be advantageous to combine the Solvent Black 28 with at least one further colorant (=component d)). Component d) is preferably selected from non-nucleating colorants other than b). These include non-nucleating dyes, non-nucleating pigments and mixtures thereof. Examples of non-nucleating dyes are Solvent Yellow 21 (commercially available as Oracet Yellow 160 FA from BASF SE) or Solvent Blue 104 (commercially available as Solvaperm Blue 2B from Clariant). Examples of non-nucleating pigments are Pigment Brown 24 (commercially available as Sicotan Yellow K 2011 FG from BASF SE). Also useful as component d) are small amounts of at least one white pigment. Suitable white pigments are titanium dioxide (Pigment White 6), barium sulfate (Pigment White 22), zinc sulfide (Pigment White 7), etc. In a specific embodiment, the molding composition of the invention comprises, as component d), 0.001% to 0.5% by weight of at least one white pigment. For example, the molding composition may comprise 0.05% by weight of titanium dioxide of the Kronos 2220 brand from Kronos.

If pigments which also act as filler and reinforcer e) are used as component d), the amount of these pigments is counted in full both as part of component d) and of component e).

The manner and amount of the addition is guided by the hue, i.e. the desired shade of the black color. For example, with Solvent Yellow 21, it is possible to move the hue of the black color in the CIELAB color space from, for example, b*=−1.0 in the direction of +b*, i.e. in the yellow direction. This method is known to those skilled in the art as color shading. The measurement is effected in accordance with DIN 6174 “Colorimetric evaluation of colour coordinates and colour differences according to the approximately uniform CIELAB colour space” or the successor standard.

The term “filler and reinforcer” (=component e)) is understood in a broad sense in the context of the invention and comprises particulate fillers, fibrous substances and any intermediate forms. Particulate fillers may have a wide range of particle sizes ranging from particles in the form of dusts to large grains. Useful filler materials include organic or inorganic fillers and reinforcers. For example, it is possible to use inorganic fillers, such as kaolin, chalk, wollastonite, talc, calcium carbonate, silicates, titanium dioxide, zinc oxide, graphite, glass particles, e.g. glass beads, nanoscale fillers, such as carbon nanotubes, carbon black, nanoscale sheet silicates, nanoscale alumina (Al₂O₃), nanoscale titania (TiO₂), graphene, permanently magnetic or magnetizable metal compounds and/or alloys, sheet silicates and nanoscale silica (SiO₂). The fillers may also have been surface treated.

Examples of sheet silicates usable in the molding compositions of the invention include kaolins, serpentines, talc, mica, vermiculites, illites, smectites, montmorillonite, hectorite, double hydroxides or mixtures thereof. The sheet silicates may have been surface treated or may be untreated.

In addition, it is possible to use one or more fibrous substances. These are preferably selected from known inorganic reinforcing fibers, such as boron fibers, glass fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is especially preferable to use glass fibers, carbon fibers, aramid fibers, boron fibers, metal fibers or potassium titanate fibers.

Specifically, chopped glass fibers are used. More particularly, component e) comprises glass fibers and/or carbon fibers, preference being given to using short fibers. These preferably have a length in the range from 2 to 50 mm and a diameter of 5 to 40 μm. Alternatively, it is possible to use continuous fibers (rovings). Suitable fibers are those having a circular and/or noncircular cross-sectional area, in which latter case the ratio of dimensions of the main cross-sectional axis to the secondary cross-sectional axis is especially >2, preferably in the range from 2 to 8 and more preferably in the range from 3 to 5.

In a specific embodiment, component e) comprises what are called “flat glass fibers”. These specifically have a cross-sectional area which is oval or elliptical or elliptical and provided with indentation(s) (called “cocoon” fibers), or rectangular or virtually rectangular. Preference is given here to using glass fibers with a noncircular cross-sectional area and a ratio of dimensions of the main cross-sectional axis to the secondary cross-sectional axis of more than 2, preferably of 2 to 8, especially of 3 to 5.

For reinforcement of the molding compositions of the invention, it is also possible to use mixtures of glass fibers having circular and noncircular cross sections. In a specific embodiment, the proportion of flat glass fibers, as defined above, predominates, meaning that they account for more than 50% by weight of the total mass of the fibers.

If rovings of glass fibers are used as component e), these preferably have a diameter of 10 to 20 μm, preferably of 12 to 18 μm. In this case, the cross section of the glass fibers may be round, oval, elliptical, virtually rectangular or rectangular. Particular preference is given to what are called flat glass fibers having a ratio of the cross-sectional axes of 2 to 5. More particularly, E glass fibers are used. However, it is also possible to use all other glass fiber types, for example A, C, D, M, S or R glass fibers or any desired mixtures thereof, or mixtures with E glass fibers.

The polyamide molding compositions of the invention can be produced by the known processes for producing long fiber-reinforced rod pellets, especially by pultrusion processes, in which the continuous fiber strand (roving) is fully saturated with the polymer melt and then cooled and cut. The long fiber-reinforced rod pellets obtained in this manner, which preferably have a pellet length of 3 to 25 mm, especially of 4 to 12 mm, can be processed further by the customary processing methods, for example injection molding or press molding, to give moldings.

Suitable additives f) are heat stabilizers, flame retardants, light stabilizers (UV stabilizers, UV absorbers or UV blockers), lubricants, dyes, nucleating agents, metallic pigments, metal flakes, metal-coated particles, antistats, conductivity additives, demolding agents, optical brighteners, defoamers, etc.

As component f), the molding compositions of the invention comprise preferably 0.01% to 3% by weight, more preferably 0.02% to 2% by weight and especially 0.1% to 1.5% by weight of at least one heat stabilizer, based on the total weight of components a), b), c), d) and f).

The heat stabilizers are preferably selected from copper compounds, secondary aromatic amines, sterically hindered phenols, phosphites, phosphonites and mixtures thereof.

If a copper compound is used, the amount of copper is preferably 0.003% to 0.5%, especially 0.005% to 0.3% and more preferably 0.01% to 0.2% by weight, based on the total weight of components a), b), c), d) and f).

If stabilizers based on secondary aromatic amines are used, the amount of these stabilizers is preferably 0.2% to 2% by weight, more preferably from 0.2% to 1.5% by weight, based on the total weight of components a), b), c), d) and f).

If stabilizers based on sterically hindered phenols are used, the amount of these stabilizers is preferably 0.1% to 1.5% by weight, more preferably from 0.2% to 1% by weight, based on the total weight of components a), b), c), d) and f).

If stabilizers based on phosphites and/or phosphonites are used, the amount of these stabilizers is preferably 0.1% to 1.5% by weight, more preferably from 0.2% to 1% by weight, based on the total weight of components a), b), c), d) and f).

Suitable compounds f) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, CuI, CuCN and Cu₂O and to the divalent copper compounds CuCl₂, CuSO₄, CuO, copper(II) acetate or copper(II) stearate.

The copper compounds are commercially available and/or the preparation thereof is known to those skilled in the art. The copper compound may be used as such or in the form of concentrates. A concentrate is understood to mean a polymer, preferably of the same chemical nature as component A), comprising a high concentration of the copper salt. The use of concentrates is a standard method and is employed particularly frequently when very small amounts of an input material are to be metered. Advantageously, the copper compounds are used in combination with further metal halides, especially alkali metal halides, such as NaI, KI, NaBr, KBr, in which case the molar ratio of metal halide to copper halide is 0.5 to 20, preferably 1 to 10 and more preferably 3 to 7.

Particularly preferred examples of stabilizers which are based on secondary aromatic amines and are usable in accordance with the invention are adducts of phenylenediamine with acetone (Naugard A), adducts of phenylenediamine with linolenic acid, 4,4′-bis(α,α-dimethylbenzyl)diphenylamine (Naugard® 445), N,N′-dinaphthyl-p-phenylenediamine, N-phenyl-N′-cyclohexyl-p-phenylenediamine or mixtures of two or more thereof.

Preferred examples of stabilizers which are usable in accordance with the invention and are based on sterically hindered phenols include N,N′-hexamethylenebis-3-(3,5-di-tert-butyl-4-hydroxyphenyl)propionamide, bis(3,3-bis(4′-hydroxy-3′-tert-butylphenyl) butanoic acid) glycol ester, 2,1′-thioethyl bis(3-(3,5-di-tert-butyl-4-hydroxyphenyl)) propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo-[d,g]-1,3,2-dioxaphosphocin, 6-fluoro-2,4,8,10-tetra-tert-butyl-12-methyldibenzo-[d,g]-1,3,2-dioxaphosphocin, bis(2,4-di-tert-butyl-6-methylphenyl)methyl phosphite and bis(2,4-di-tert-butyl-6-methylphenyl) ethyl phosphite. More particularly, preference is given to tris[2-tert-butyl-4-thio(2′-methyl-4′-hydroxy-5′-tert-butyl)phenyl-5-methyl]phenyl phosphite and tris(2,4-di-tert-butylphenyl)phosphite (Hostanox® PAR24: commercial product from BASF SE).

A preferred embodiment of the heat stabilizer consists in the combination of organic heat stabilizers (especially Hostanox PAR 24 and Irganox 1010), a bisphenol A-based epoxide (especially Epikote 1001) and copper stabilization based on CuI and KI. An example of a commercially available stabilizer mixture consisting of organic stabilizers and epoxides is Irgatec NC66 from BASF SE. More particularly, preference is given to heat stabilization exclusively based on CuI and KI. Aside from the addition of copper or copper compounds, the use of further transition metal compounds, especially metal salts or metal oxides of group VB, VIB, VIIB or VIIIB of the Periodic Table, is ruled out. In addition, it is preferable not to add any transition metals of group VB, VIB, VIIB or VIIIB of the Periodic Table, for example iron powder or steel powder, to the molding composition of the invention.

The molding compositions of the invention comprise preferably 0% to 30% by weight, more preferably 0% to 20% by weight, based on the total weight of components a), b), c), d) and f), of at least one flame retardant as additive f). When the molding compositions of the invention comprise at least one flame retardant, they preferably do so in an amount of 0.01% to 30% by weight, more preferably of 0.1% to 20% by weight, based on the total weight of components a), b), c), d) and f). Useful flame retardants f) include halogenated and halogen-free flame retardants and synergists thereof (see also Gächter/Müller, 3rd edition 1989 Hanser Verlag, chapter 11). Preferred halogen-free flame retardants are red phosphorus, phosphinic or diphosphinic salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art, and also polymeric melamine phosphate (CAS No.: 56386-64-2 or 218768-84-4, and also EP 1095030), ammonium polyphosphate, trishydroxyethyl isocyanurate (optionally also ammonium polyphosphate in a mixture with trishydroxyethyl isocyanurate) (EP 584567). Further N-containing or P-containing flame retardants, or PN condensates suitable as flame retardants, can be found in DE 10 2004 049 342, as can the synergists customary for this purpose, such as oxides or borates. Suitable halogenated flame retardants are, for example, oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, Dechlorane, which are usually used with antimony oxides as synergists (for details and further flame retardants see DE-A-10 2004 050 025).

The polyamide molding compositions are produced by methods known per se. These include the mixing of the components in the appropriate proportions by weight. The mixing of the components is preferably accomplished at elevated temperatures by commixing, blending, kneading, extruding or rolling. The mixing temperature is preferably within a range from 220° C. to 340° C., more preferably from 240 to 300° C. and especially from 250 to 290° C. The person skilled in the art is very well aware of the suitable methods.

The color impression of the molding compositions colored in accordance with the invention and of shaped bodies and fibers produced therefrom can be described by means of the CIE standard color system. DIN EN ISO 11664, Parts 1 to 4 of July 2011, stipulates spectral value functions for use in colorimetry and describes the corresponding color measurements. It is based on the predecessor standards DIN 5033 “Colorimetry” and DIN 6174 “Colorimetric evaluation of colour coordinates and colour differences according to the approximately uniform CIELAB colour space”. The construction of suitable hue measuring instruments and of the illumination optics and tolerances thereof is described, for example, in DIN 5033 Part 7. According to the standard, the illuminant is cited first, then the viewing geometry. The specifications of these standards are incorporated here by reference in their entirety. The measurement is effected as the ratio of reflection or transmission of a test specimen relative to a reference standard (=white standard) and as a result is independent of the light source. The spectral data together with the tabulated standard color values can be used to determine the values L*, a* and b*. The reflected or transmitted light is evaluated with a “monochromator” system consisting of 1.) an optical diffraction grating (prism) which splits the light and 2.) projects it onto a (photo)diode array which measures data points in the spectrum at fixed wavelength intervals (1, 2, 5, 10 or 20 nm intervals; standard: 10 nm). According to the nature of the surface, the interaction of the material surface with the light (reflection) may be directed or diffuse. The effect of scattered light is that a dark surface has a lightened appearance on viewing. This is taken into account by means of standard ball geometries, for example:
di:8°→diffuse: 8°, specular component included (SCI), diffuse illumination without directional dependences, virtually independent of the material surface (for example by virtue of gloss differences or texture)
de:8°→diffuse: 8°, specular component excluded (SCE), partly diffuse illumination having good correlation with visual assessment in a partly diffuse environment, characterizes the effect of the surface on the color impression.

The use of Solvent Black 28 enables the production of colored thermoplastic molding compositions which exhibit a deep black color impression. In the CIELAB color space according to DIN 6174, in the case of measurement without the specular component in accordance with DIN 5033, L* values of not more than 20 are achieved. In the case of measurement with the specular component, L* values of not more than 30 are achieved.

Shaped Bodies

The present invention further relates to shaped bodies which are produced using the copolyamides or polyamide molding compositions of the invention.

The black-colored polyamides can be used to produce moldings by means of any suitable processing techniques. Suitable processing techniques are especially injection molding, extrusion, coextrusion, blow molding, thermoforming, fiber spinning or any other known polymer shaping method. These and further examples can be found, for example, in “Einfärben von Kunststoffen” [Coloring of Plastics], VDI-Verlag, ISBN 3-18-404014-3.

The polyamides obtainable by the process of the invention are suitable for production of films, monofilaments, fibers, yarns or textile fabrics. In this context, the polyamides colored black in accordance with the invention are generally found to be particularly stable to processing during a melt extrusion through slot dies or annular dies to form flat or blown films, and through annular dies of smaller diameter to form monofilaments.

The polyamides obtainable by the process of the invention are further advantageously suitable for use for automotive applications, for production of moldings for electrical and electronic components, and especially also in the high-temperature sector.

A specific embodiment is that of shaped bodies in the form of or as part of a component for the automotive sector, especially selected from cylinder head covers, engine hoods, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, heating elements, securing parts.

Possible uses in automobile interiors are for dashboards, steering-column switches, seat components, headrests, center consoles, gearbox components and door modules, and possible uses in automobile exteriors are for A, B, C, or D pillar covers, spoilers, door handles, exterior mirror components, windshield wiper components, windshield wiper protective housings, decorative grilles, cover strips, roof rails, window frames, sunroof frames, antenna covers, front and rear lights, engine hoods, cylinder head covers, intake pipes, windshield wipers, and exterior bodywork parts.

A further specific embodiment is that of shaped bodies as or as part of an electrical or electronic passive or active component, of a printed circuit board, of part of a printed circuit board, of a housing constituent, of a film, or of a wire, more particularly in the form of or as part of a switch, of a plug, of a bushing, of a distributor, of a relay, of a resistor, of a capacitor, of a winding or of a winding body, of a lamp, of a diode, of an LED, of a transistor, of a connector, of a regulator, of an integrated circuit (IC), of a processor, of a controller, of a memory element and/or of a sensor.

The polyamides of the invention are additionally specifically suitable for use in soldering operations under lead-free conditions (lead free soldering), for production of plug connectors, microswitches, microbuttons and semiconductor components, especially reflector housings of light-emitting diodes (LEDs).

A specific embodiment is that of shaped bodies as securing elements for electrical or electronic components, such as spacers, bolts, fillets, push-in guides, screws and nuts.

Especially preferred is a molding in the form of or as part of a socket, of a plug connector, of a plug or of a bushing. The molding preferably includes functional elements which require mechanical toughness. Examples of such functional elements are film hinges, snap-in hooks and spring tongues.

Possible uses of the polyamides of the invention for the kitchen and household sector are for production of components for kitchen machines, for example fryers, smoothing irons, knobs, and also applications in the garden and leisure sector, for example components for irrigation systems or garden equipment and door handles.

Fibers

Processes for producing polyamide fibers are very well known to those skilled in the art.

Laser Transmission Welding

The invention further provides for the use of a polyamide composition of the invention for production of moldings for laser transmission welding. The polyamide composition of the invention is especially suitable for production of laser-transparent moldings.

As mentioned at the outset, laser transmission welding is a joining process in which two joining partners generally made from thermoplastic polymers are joined cohesively to one another. It is a prerequisite for the use of laser transmission welding that the radiation emitted by the laser first penetrates a joining partner (i.e. a molding) having sufficient transparency for laser light of the wavelength of 600 to 1200 nm used. This molding is also referred to in the context of the invention as laser-transparent molding. Subsequently, the laser light is then absorbed by a second joining partner (molding) which is in contact with the laser-transparent molding and is also called laser-absorbent molding hereinafter. The fundamental principles of laser transmission welding are known to those skilled in the art.

The transmission capacity of a polymer molding for laser light of a wavelength of 600 to 1200 nm can be measured, for example, with a spectrophotometer and an integrating photometer sphere. This measurement arrangement also enables determination of the diffuse component of the transmitted radiation.

Suitable laser sources for laser transmission welding emit within a wavelength range of about 600 to 1200 nm. Examples of commonly used lasers are high-power diode lasers (HDL, λ=800-1100 nm) and solid-state lasers (e.g. Nd:YAG lasers, λ=1060-1090 nm).

With regard to the polyamide composition used for production of the moldings for laser transmission welding, reference is made in full to the above details relating to the polyamide compositions of the invention. In addition, with regard to the polyamide molding compositions for production of moldings from the polyamide compositions of the invention, reference is made in full to the above details. It should be noted merely that the laser-transparent molding is produced using essentially no components which absorb in the wavelength range of the laser used for the laser transmission welding. This is especially true when further pigments and/or dyes are used in the laser-transparent molding in addition to the chromium complex dye used in accordance with the invention. Preferably, the laser-transparent molding is produced using, in addition to the chromium complex dye used in accordance with the invention, no further pigments and/or dyes which absorb or scatter within the wavelength range of relevance for the laser process.

Laser-absorbent moldings used may generally be moldings made from any laser-absorbent materials. These may, for example be composites, thermosets or preferably shaped bodies made from suitable thermoplastic molding compositions. Suitable thermoplastic molding compositions are molding compositions having sufficient laser absorption in the wavelength range employed. Suitable thermoplastic molding compositions may, for example, preferably be thermoplastics which are laser-absorbent due to addition of colorants, e.g. inorganic pigments, for example carbon black, and/or due to addition of organic dyes or pigments or other additives. Suitable organic pigments for achieving laser absorption are, for example, preferably IR-absorbent organic compounds as are described in DE 199 60 104 A1 for example.

The production of the polyamide composition for production of moldings for use for the laser transmission welding is effected by processes known per se. Reference is made here to the abovementioned processes for producing the polyamide composition. These include the mixing of the components in the appropriate proportions by weight. The mixing of the components is preferably accomplished at elevated temperatures by commixing, blending, kneading, extruding or rolling. The mixing temperature is preferably within a range from 220° C. to 340° C., more preferably from 240 to 300° C. and especially from 250 to 290° C. It may be advantageous to premix individual components. It is also possible to produce the moldings directly from a physical mixture (dryblend) of premixed components and/or individual components which has been produced well below the melting point of the polyamide. In that case, the mixing temperature is preferably 0 to 100° C., more preferably 10 to 50° C., especially ambient temperature. The molding compositions can be processed to give moldings by customary methods, for example by injection molding or extrusion. The moldings thus obtained are advantageously suitable for use in the laser transmission welding process. For example, laser-transparent moldings based on the polyamide composition of the invention can be mounted in a permanent and stable manner on laser-absorbent moldings. They are therefore especially suitable, for example, for materials for covers, housings, accessory parts, sensors, for applications in, for example, the automotive, electrical engineering, electronics, telecommunications, information technology, computer, household, sports, medical, or entertainment sectors.

### DESCRIPTION OF FIGURES

FIG. 1 shows the diffuse transmission of the chromium complex dye of the invention and nigrosin base (=Solvent Black 7) as a function of wavelength. The measurement was effected on polyamide test specimens made from PA6 (Ultramid B3S from BASF SE) having a thickness of 2 mm and a dye content of 0.05% by weight by means of an Agilent Technologies Cary 5000 spectrophotometer.

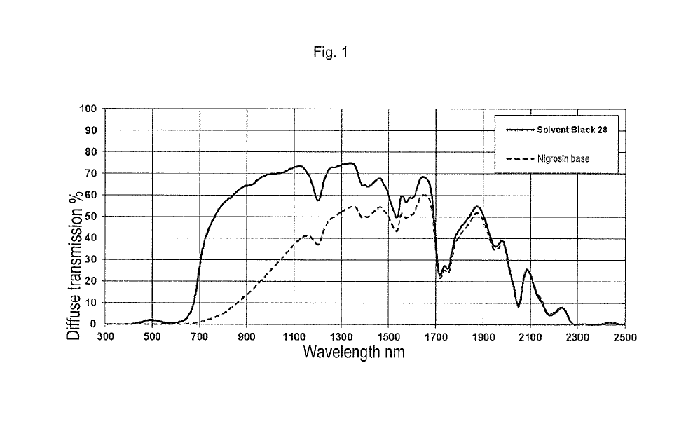

The examples which follow serve to illustrate the invention, but without restricting it in any way.

### EXAMPLES

### Example 1

99.95 parts polyamide PA6 (Ultramid B3S from BASF) were premixed in a tumbling mixer with 0.05 part Solvent Black 28 (Orasol Black 045 from BASF) for 10 minutes and then extruded and pelletized using a twin-shaft extruder having a diameter of 18 mm and an L/D ratio of 44 at barrel temperature 260° C. For this purpose, the natural-colored polyamide pellets were dried beforehand in a drying oven at 100° C. for 4 hours, such that the moisture content was below 0.1%. For this purpose, the moisture content was determined by means of a thermal balance. The homogeneous pellets obtained were injection-molded on an injection molding machine at melt temperature 260° C., 280° C. and 300° C. to give plaques of thickness 2 mm and of dimensions 45×60 mm, and were assessed both visually and analytically.

Colorimetry in accordance with DIN 6174 and evaluation in accordance with DIN EN 12877-2 showed a dE at 280° C. of 2.1 and a dE at 300° C. of 4.8. A visual determination of the color difference at 300° C., by means of a gray scale in accordance with “DIN EN 20105-A02 Tests for colour fastness”, gave a grade of 4-5 and hence only a small color change was found.

The migration of the black dye out of the polyamide was tested by means of standard EN 14469-4 “Pigments and extenders—Testing of colouring materials in plasticized polyvinyl chloride (PVC-P) Part 4: Determination of bleeding of colouring materials”. The grade of 5 obtained showed non-migratory behavior of the Solvent Black 28 dye.

The transparency of the black 2 mm-thick plaques obtained in the near-infrared (NIR) was measured by means of the Agilent Technologies Cary 5000 UV-VIS-IR spectrometer (with DRA 2500 Diffuse Reflectance Accessory) within the wavelength range of 300 nm to 2500 nm. A transmission of more than 50% was found within the wavelength range from 800 to 900 nm which is of technical interest, and a transmission of more than 60% in the wavelength range from 900 to 1100 nm.

Determination of the crystallization temperature of the colored polyamide in the cooling phase by means of differential scanning calorimetry (DSC) in accordance with DIN EN ISO 11357 gave a temperature of 222.2° C., whereas a temperature of 222.5° C. was measured in example 5. It was thus possible to demonstrate surprisingly good thermal stability, very good migration resistance and very good transmission in the near infrared region.

### Example 2

99.4 parts polyamide PA6 (Ultramid B3S from BASF) were premixed in a tumbling mixer with 0.1 part Solvent Black 28 (Orasol Black 045 from BASF) and 0.5 part titanium dioxide (Kronos 2220 from Kronos) for 10 minutes and then extruded and pelletized using a twin-shaft extruder having a diameter of 18 mm and an L/D ratio of 44 at barrel temperature 260° C. For this purpose, the natural-colored polyamide pellets were dried beforehand in a drying oven at 100° C. for 4 hours, such that the moisture content was below 0.1%. For this purpose, the moisture content was determined by means of a thermal balance. The homogeneous pellets obtained were injection-molded on an injection molding machine at melt temperature 260° C., 280° C. and 300° C. to give plaques of thickness 2 mm and of dimensions 45×60 mm, and were assessed both visually and analytically.

Colorimetry in accordance with DIN 6174 and evaluation in accordance with DIN EN 12877-2 showed a dE at 280° C. of 2.0 and a dE at 300° C. of 5.0. A visual determination of the color difference at 300° C., by means of a gray scale in accordance with “DIN EN 20105-A02 Tests for colour fastness”, gave a grade of 4-5 and hence only a small color change was found.

The migration of the black dye out of the polyamide was tested by means of standard EN 14469-4 “Pigments and extenders—Testing of colouring materials in plasticized polyvinyl chloride (PVC-P) Part 4: Determination of bleeding of colouring materials”. The grade of 5 obtained showed non-migratory behavior of the Solvent Black 28 dye.

It was thus possible to demonstrate surprisingly good thermal stability, very good migration resistance and comparable crystallization behavior of the PA to example 5.

### Example 3 (Comparative)

98 parts polyethylene (Grade M80064 from Sabic) were premixed in a tumbling mixer with 2 parts Solvent Black 28 (Orasol Black 045 from BASF) for 10 minutes and extruded in a twin-shaft extruder having a diameter of 18 mm and an L/D ratio of 44 at barrel temperature 210° C. A significant odor developed from the extruder nozzle; the polymer strands had expanded in the foam mold. The production of plaques by means of injection molding machines was not possible.

Incorporation and black coloring of the polyethylene by means of Solvent Black 28 was thus not possible.

### Example 4 (Comparative)

99.9 parts polyamide PA6 (Ultramid B3S from BASF) were premixed in a tumbling mixer with 0.1 part Solvent Violet 13 (Orasol Blue 640 from BASF) for 10 minutes and then extruded and pelletized using a twin-shaft extruder having a diameter of 18 mm and an L/D ratio of 44 at barrel temperature 260° C. For this purpose, the natural-colored polyamide pellets were dried beforehand in a drying oven at 100° C. for 4 hours, such that the moisture content was below 0.1%. For this purpose, the moisture content was determined by means of a thermal balance. The homogeneous pellets obtained did not show the expected pure blue color, but a dirty gray hue. It was clearly apparent that the dye did not have any coloring effect.

### Example 5 (Comparative)

99.95 parts polyamide PA6 (Ultramid B3S from BASF) were premixed in a tumbling mixer with 0.05 part of the Solvent Black 7 dye (Nubian black TN-870 from Orient Chemicals) for 10 minutes and then extruded and pelletized using a twin-shaft extruder having a diameter of 18 mm and an L/D ratio of 44 at barrel temperature 260° C. For this purpose, the natural-colored polyamide pellets were dried beforehand in a drying oven at 100° C. for 4 hours, such that the moisture content was below 0.1%. For this purpose, the moisture content was determined by means of a thermal balance. The homogeneous pellets obtained were injection-molded on an injection molding machine at melt temperature 260° C., 280° C. and 300° C. to give plaques of thickness 2 mm and of dimensions 45×60 mm.

The transparency of the black 2 mm-thick plaques obtained in the near-infrared (NIR) was measured by means of a UV-VIS-IR spectrometer (see above) within the wavelength range of 300 nm to 2500 nm. A transmission of below 15% was found within the wavelength range from 800 to 900 nm which is of technical interest, and a transmission of well below 40% in the wavelength range from 900 to 1100 nm.

It was thus possible to demonstrate much poorer transmission in the near infrared region (NIR) compared to Solvent Black 28.

### Example 6

99.95 parts glass-modified polyamide PA6 (Ultramid B3EG7 from BASF) were premixed in a tumbling mixer with 0.05 part Solvent Black 28 (Orasol Black 045 from BASF) for 10 minutes and then extruded and pelletized using a twin-shaft extruder having a diameter of 18 mm and an L/D ratio of 44 at barrel temperature 280° C. For this purpose, the natural-colored polyamide pellets were dried beforehand in a drying oven at 100° C. for 4 hours, such that the moisture content was below 0.1%. The homogeneous pellets obtained were injection-molded on an injection molding machine at melt temperature 260° C., 280° C. and 300° C. to give plaques of thickness 2 mm and of dimensions 45×60 mm, and were assessed both visually and analytically.

Colorimetry in accordance with DIN 6174 and evaluation in accordance with DIN EN 12877-2 showed a dE at 280° C. of 1.2 and a dE at 300° C. of 6.1. A visual determination of the color difference at 300° C., by means of a gray scale in accordance with “DIN EN 20105-A02 Tests for colour fastness”, gave a grade of 4-5 and hence only a small color change was found. It was thus possible to demonstrate surprisingly good thermal stability.

1. A polyamide composition comprising
a) at least one synthetic polyamide and
b) at least one chromium complex dye selected from the group consisting of a compound of formula (A1), a compound of formula (A2), and a compound of formula (A3):

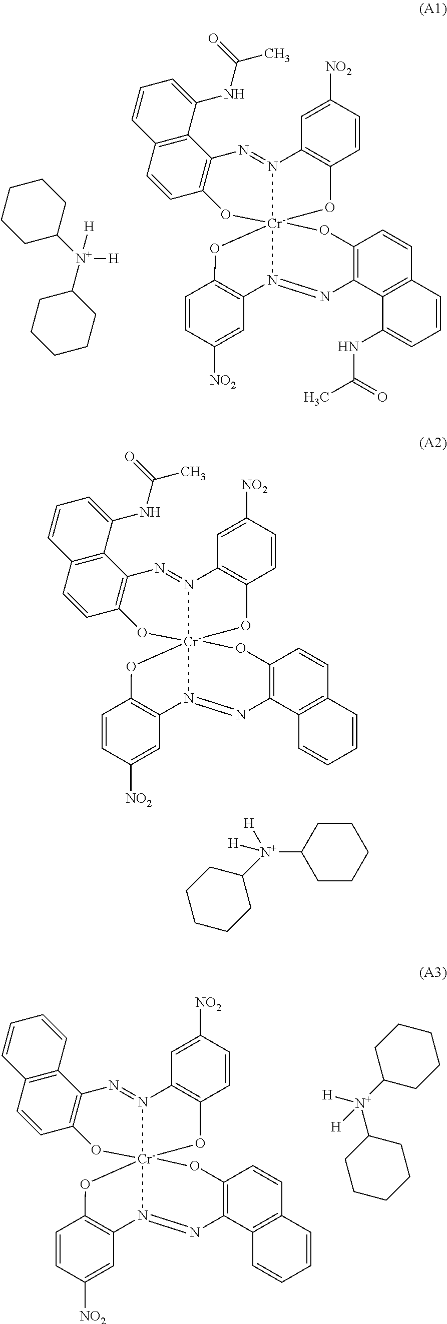

2. The polyamide composition according to claim 1, wherein the at least one synthetic polyamide is selected from the group consisting of PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, PA 6.T, PA 9.T, PA_8.T, PA 10.T, PA 12.T, PA 6.I, PA 8.I, PA 9.I, PA 10.I, PA 12.I, PA 6.T/6, PA 6.T/10, PA 6.T/12, PA 6.T/6.I, PA6.T/8.T, PA 6.T/9.T, PA 6.T/10T, PA 6.T/12.T, PA 12.T/6.T, PA 6.T/6.I/6, PA 6.T/6.I/12, PA 6.T/6.I/6.10, PA 6.T/6.I/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10T/10.I/6.T, PA 10.T/6.I, PA 4.T/4.I/46, PA 4.T/4.I/6.6, PA 5.T/5.I, PA 5.T/5.I/5.6, PA 5.T/5.I/6.6, PA 6.T/6.I/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.I/8.T/8.I, PA 6.T/6.I/10.T/10.I, PA 6.T/6.I/IPDA.T/IPDA.I, PA 6.T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T, and copolymers thereof.

3. The polyamide composition according to claim 1 wherein the at least one chromium complex dye b) is present in an amount of 0.0001% by weight to 5% by weight, based on a total weight of the polyamide composition.

4. The polyamide composition according to claim 1, wherein the composition further comprises at least one of the following c)-f):
c) at least one thermoplastic polymer other than component a),
d) at least one colorant other than component b),
e) at least one filler and reinforcer,
f) at least one additive other than components a) to e).

5. The polyamide composition according to claim 4, comprising
a) 5% by weight to 99.9999% by weight of the at least one synthetic polyamide,
b) 0.0001% by weight to 5% by weight of the at least one chromium complex dye selected from the group consisting of a compound of formula (A1), a compound of formula (A2), and a compound of formula (A3),
c) 0% by weight to 94.9999% by weight of at the least one thermoplastic polymer other than component a),
d) 0% by weight to 10% by weight of the at least one colorant other than component b), and
f) 0% by weight to 50% by weight of the at least one additive other than components a) to d),
with the proviso that components a), b), c), d) and f) add up to 100% by weight.

6. The polyamide composition according claim 4, wherein component c) is present and is selected from
homo- or copolymers which comprise, in polymerized form, at least one monomer selected from the group consisting of C₂-C₁₀ monoolefins, 1,3-butadiene, 2-chloro-1,3-butadiene, vinyl alcohol, C₂-C₁₀-alkyl esters of vinyl alcohol, vinyl chloride, vinylidene chloride, vinylidene fluoride, tetrafluoroethylene, glycidyl acrylate, glycidyl methacrylate, acrylates with alcohol components of branched C₁-C₁₀-alcohols, acrylates with alcohol components of unbranched C₁-C₁₀-alcohols, methacrylates with alcohol components of branched C₁-C₁₀-alcohols, methacrylates with alcohol components of unbranched C₁-C₁₀-alcohols vinylaromatics, acrylonitrile, methacrylonitrile, α,β-ethylenically unsaturated monocarboxylic acids, α,β-ethylenically unsaturated dicarboxylic acids, and maleic anhydride;
homo- and copolymers of vinyl acetals;
polyvinyl esters;
polycarbonates (PC);
polyesters;
polyethers;
polyether ketones;
thermoplastic polyurethanes (TPU);
polysulfides;
polysulfones;
polyether sulfones;
cellulose alkyl esters;
and mixtures thereof.

7. The polyamide composition according to claim 4, wherein component c) is present and is selected from the group consisting of styrene copolymers, polyalkyl(meth)acrylates, polycarbonates, and mixtures thereof.

8. The polyamide composition according to claim 4, wherein component d) is present and comprises at least one non-nucleating colorant other than component b).

9. The polyamide composition according to claim 4, wherein component d) is present and comprises at least one white pigment.

10. The polyamide composition according to claim 4, having, in the CIELAB color space according to DIN 6174 with the specular component included, an L* value of not more than 30, having, in the CIELAB color space according to DIN 6174 with the specular component excluded, an L* value of not more than 20, or having, in the CIELAB color space according to DIN 6174 with the specular component included, an L* value of not more than 30 and with the specular component excluded, an L* value of not more than 20.

11. The polyamide composition according to claim 1, wherein the composition is.

12. A method for producing black molding for use in motor vehicles, domestic appliances, electrical appliances, decorative strips, and exterior paneling, the method comprising processing the polyamide composition as defined in claim 11.

13. A shaped body or a polyamide fiber comprising the polyamide composition according to claim 1.

14. A process for producing the polyamide composition of claims of claim 1, in which the at least one synthetic polyamide a), the at least one chromium complex dye b), and optionally further additives, are mixed with one another while heating to a temperature in a range from 160° C. to 340° C.

15. A molding for laser transmission welding, the molding comprising the polyamide composition of claim 1.
